(19) United States
(12) Patent Application Publication
(10) Pub. No.: US 2025/0210772 A1
(43) Pub. Date: Jun. 26, 2025

(54) Battery Pack, System Comprising the Battery Pack and an Electrically Driven Working Tool, and Method for Producing the Battery Pack

(71) Applicant: Andreas Stihl AG & Co. KG, Waiblingen (DE)

(72) Inventors: Torsten KOLLER, Leinfelden-Echterdingen (DE); Moritz PICKHARDT, Kiel (DE)

(21) Appl. No.: 18/848,984

(22) PCT Filed: Mar. 13, 2023
(86) PCT No.: PCT/EP2023/056282

§ 371 Date: Sep. 20, 2024

(30) Foreign Application Priority Data
Mar. 23, 2022 (EP) 22163822.4

(51) Int. Cl. H01M 50/24; H01M 50/242; H01M 50/247; H01M 50/296

(52) U.S. Cl. CPC H01M 50/24; H01M 50/242; H01M 50/247; H01M 50/296; H01M 2220/30

(57) ABSTRACT

A battery pack has a plurality of pack power contacts, the pack power contacts having touch points for the user-releasable touching of tool power contacts of an electrically powered tool for supplying the tool with electric drive power from the battery pack, and a pack housing. The pack housing has at least one flame-retardant housing component and at least one impact-protection housing component. The at least one flame-retardant housing component has at least one flame-retardant material acting as a flame retardant for the battery pack. The least one impact-protection housing component has at least one impact-protection material that differs from the flame-retardant material for providing impact protection for the battery pack. The touch points are located in the region of the at least one flame-retardant housing component and not in the region of the at least one impact-protection housing component.

### FIELD OF APPLICATION

The invention relates to a battery pack, a system comprising the battery pack and an electrically driven working tool, and a method for producing the battery pack.

### BACKGROUND AND SUMMARY

The problem addressed by the invention is that of providing a battery pack, a system comprising the battery pack and an electrically driven working tool, and a method for producing the battery pack, each of which has improved properties.

The invention solves this problem by providing a battery pack and a method for producing the battery pack described in the independent claims. Advantageous developments and/or embodiments of the invention, in particular of a system comprising the battery pack and an electrically driven working tool, are described in the dependent claims.

The battery pack according to the invention has a plurality of pack power contacts and a pack housing. The pack power contacts are designed with, in particular, respective contact points for user-releasable touching of tool power contacts of an electrically driven working tool for supplying the, in particular, touched working tool with electrical drive power from the battery pack. The pack housing has at least one flame-retardant housing component and at least one impact-resistant housing component. The at least one flame-retardant housing component comprises at least one flame-retardant material for protecting the battery pack against fire. The at least one impact-resistant housing component comprises at least one impact-resistant material, different from the flame-retardant material, for protecting the battery pack against impact. The contact points, in particular the pack power contacts, in particular in each case and/or completely, are arranged in the region of the at least one flame-retardant housing component and not, in particular in the region of the at least one impact-resistant housing component.

This, in particular the at least one flame-retardant housing component and the arrangement of the contact points in the region of the at least one flame-retardant housing component and not the at least one impact-resistant housing component, enables the battery pack to be protected against fire. In addition, this, in particular the at least one impact-resistant housing component, enables protection of the battery pack against impact. Thus, this enables a multi-function of the pack housing and/or, in particular thus, an improved protection of the battery pack.

In particular, the battery pack and/or the working tool can be mobile or portable. In particular, mobile can mean a mass of at most 50 kg (kilograms), in particular at most 20 kg, in particular at most 10 kg, in particular at most 5 kg, and/or at least 0.25 kg, in particular at least 0.5 kg, in particular at least 1 kg, in particular at least 2 kg.

The working tool can be ground-and/or hand-guided, in particular hand-held, and/or a garden, forestry, ground and/or construction working tool. In particular, the working tool can be a saw, in particular a chainsaw, or a long-reach tree pruner, or a hedge trimmer, or a hedge cutter, or a pruner, or a lopper, a grinder, or a blower, or a leaf blower, or a suction device, or a leaf vacuum, or a cleaning device, or a high-pressure cleaner, or a sweeper, or a sweeping roller, or a sweeping brush, or a lawn mower, or a grass shear, or a brush cutter, or a scarifier. Additionally or alternatively, the working tool can have a processing mechanism and/or a drive motor, in particular an electric drive motor, in particular for driving the processing mechanism. In particular, the drive power can be for the drive motor.

The battery pack can be designed to be mechanically connected to the working tool and/or to be user-replaceable or user-removable in particular from or out of the working tool, in particular without the use of extra tools and/or without destruction,. In particular, the battery pack can be designed to be carried by the working tool. Additionally or alternatively, the working tool can have a battery shaft, wherein the battery shaft can be designed to hold the battery pack.

The term “configured” can be used synonymously with the term “designed”.

The term “comprises” or “has” can be used synonymously with the term “includes”.

The term “connection terminal” or “connection” or “terminal” can be used synonymously with the term “contact”.

The pack power contacts can be user-releasable and/or electrical.

The contact can be user-releasable without the use of tools and/or without destruction and/or can be for electrical connection and/or direct. Additionally or alternatively, the term “contacting” can be used synonymously with the term “touching”.

The tool power contacts can be complementary or corresponding.

The supply can be automatic.

The pack housing can be an outer pack housing.

The term “fire” can be used synonymously with the term “flame”.

The term “part” can be used synonymously with the term “component”.

The at least one impact-resistant housing component can be different from the at least one flame-retardant housing component, in particular different in material, and/or, in particular, sharply or strictly separated.

The term “knock” or “fall” can be used synonymously with the term “impact”.

The term “substance” can be used synonymously with the term “material”.

The at least one flame-retardant housing component may be formed with the at least one flame-retardant material to protect the battery pack against fire. Additionally or alternatively, the at least one flame-retardant housing component with the at least one flame-retardant material need not or may not be formed as well as the at least one impact-resistant housing component with the at least one impact-resistant material for protecting the battery pack against impact.

The at least one impact-resistant housing component may be formed with the at least one impact-resistant material for impact-resistant of the battery pack. Additionally or alternatively, the at least one impact-resistant housing component with the at least one impact-resistant material need not or may not be formed as well as the at least one flame-protection housing component with the at least one flame-protection material for flame-retardant of the battery pack.

The pack power contacts can be arranged in and/or on the pack housing, in particular in and/or on an edge of the pack housing.

The term “arranged” can mean arranged, in particular fixed, spatially and/or fixedly, in particular in a stationary manner. Additionally or alternatively, the term “positioned” can be used synonymously with the term “arranged”.

The battery pack can have a plurality of battery cells. In particular, the battery cells can be arranged in the pack housing. Additionally or alternatively, the battery cells can each be individual rechargeable storage elements for electrical energy on an electrochemical basis. Further additionally or alternatively, the battery cells may be lithium-ion battery cells. Further additionally or alternatively, the battery cells may be identical, in particular of the same type and/or design. Further additionally or alternatively, a cell voltage, in particular a respective cell voltage, in particular a nominal cell voltage, of one, in particular a respective one, of the battery cells can be at least 2 V (volts), in particular at least 3.6 V, and/or at most 5 V, in particular at most 4.2 V. Additionally or alternatively, the battery cells can be round cells, prismatic cells or pouch cells.

In a development of the invention, the pack power contacts are plug connectors, in particular tulips or sockets. In particular, the tulips define the contact points. This enables simple and/or reliable establishment and/or release of the contact, in particular the electrical connection. In particular, the tool power contacts can be plug connectors, in particular fins or pins, in particular which can be pushed into the tulips.

In a development of the invention, the at least one flame-retardant housing component has at least one feed-through recess or opening, in particular slots, for feeding through the pack power contacts and/or the tool power contacts for, in particular to, touching. In particular, the contact points, in particular the pack power contacts and/or completely, are arranged in the pack housing behind the at least one feed-through recess, in particular in a direction, in particular an axial direction, from the outside to the inside. This enables accessibility from the outside to the contact points, in particular the pack power contacts.

In a development of the invention, at least one smallest distance along a surface of the pack housing, in particular in radial directions, from the contact points, in particular the pack power contacts, to the at least one impact-resistant housing component is greater than to the at least one flame-retardant housing component. In particular, the contact points, in particular the pack power contacts, are arranged, in particular completely, surrounded by the at least one flame-retardant housing component, in particular in the radial directions. Additionally or alternatively, the at least one flame-retardant housing component is arranged, in particular completely, surrounded by the at least one impact-resistant housing component, in particular in the radial directions. In other words, the at least one flame-retardant housing component can be arranged between the contact points, in particular the pack power contacts, and the at least one impact-resistant housing component, in particular in the radial directions. This enables the contact points, in particular the pack power contacts, to be arranged in the region of the at least one flame-retardant housing component and not the at least one impact-resistant housing component. In particular, the surface may be a nearest surface and/or an outer surface. Additionally or alternatively, the term “encompassed” or “enclosed” may be used synonymously for the term “surrounded”.

In a development of the invention, the contact points are arranged, in particular completely, at a maximum distance from the at least one flame-retardant housing component, in particular in any direction. Additionally or alternatively, the contact points are arranged, in particular completely, at a minimum distance of more than one distance limit value, in particular the distance limit value, from the at least one impact-resistant housing component, in particular in any direction. In particular, the distance limit value is a minimum of 1 mm (millimeter) and/or a maximum of 5 mm, in particular 3 mm. This enables the contact points, in particular the pack power contacts, to be arranged in the region of the at least one flame-retardant housing component and not the at least one impact-resistant housing component. In a development of the invention, the at least one flame-retardant housing component, in particular at least one wall of the at least one flame-retardant housing component, extends, in particular from an interior of the pack housing, to a surface of the pack housing, in particular against a direction, in particular an axial direction, from the inside to the outside. This enables simple and/or, in particular therefore, cost-effective production of the pack housing and thus of the battery pack. In particular, the surface can be an outer surface.

Additionally or alternatively, the at least one flame-retardant housing component can extend along a surface, in particular the surface of the pack housing, in particular in radial directions, from the contact points by a minimum of 1 mm and/or a maximum of 50 mm, in particular a maximum of 20 mm, in particular a maximum of 10 mm, in particular 3 mm.

In a development of the invention, the pack housing, in particular the at least one impact-resistant housing component, has at least one edge and/or at least one corner, in particular the form of a parallelepiped, in particular a cuboid. The at least one flame-retardant housing component does not extend to the at least one edge and/or the at least one corner, in particular along a surface of the pack housing, in particular in radial directions. This makes it possible for the at least one flame-retardant housing component to contribute less or not at all to the protection of the battery pack against impact and/or for the at least one impact-resistant housing component to contribute more or completely to the protection of the battery pack against impact. In particular, the at least one edge and/or the at least one corner may be rounded. Additionally or alternatively, the at least one flame-retardant housing component can be arranged, in particular completely, at a distance of at least 1 mm, in particular at least 3 mm, in particular at least 5 mm, from the at least one edge and/or the at least one corner. Further additionally or alternatively, the surface can be an outer surface.

In a development of the invention, the at least one flame-retardant housing component has a classification of, in particular at least, UL94V-0. This enables particularly good protection of the battery pack against fire. In particular, the at least one impact-resistant housing component need not or cannot have or achieve the classification of UL94V-0. For further information on the classification, in particular UL94V-0, please refer to the technical literature.

In a development of the invention, the at least one flame-retardant housing component consists partially, in particular largely, or entirely of plastic, in particular PA6/6 (GF0 to 45), with at least one flame-retardant additive. Additionally or alternatively, the at least one impact-resistant housing component consists partially, in particular for the most part, or entirely of plastic, in particular a plastic containing less or no flame-retardant additive. This, in particular the at least one flame-retardant additive, enables protection of the battery pack against fire by the at least one flame-retardant housing component, but in particular thus also brittleness of the at least one flame-retardant housing component and thus less or no protection of the battery pack against impact by the at least one flame-retardant housing component. Additionally or alternatively, this, in particular less or no flame-retardant additive, enables less or no brittleness of the at least one impact-resistant housing component and thus protection of the battery pack against impact by the at least one impact-resistant housing component, but thus also less or no protection of the battery pack against fire by the at least one impact-resistant housing component. In particular, the majority can mean more than 50%. Additionally or alternatively, the term “plastic” can be used synonymously with the term “plastics material”. In other respects, reference is made to the technical literature with regard to the at least one flame-retardant material and/or the at least one impact-resistant material, in particular the plastic and/or the at least one flame-retardant additive.

In particular, the at least one flame-retardant housing component and the at least one impact-resistant housing component can be mechanically connected to each other, in particular by latching and/or screwing.

In a development of the invention, the at least one impact-resistant housing component has at least one receiving recess or opening for receiving, and in particular for form-fit connection of, the at least one flame-retardant housing component, in particular against an, in particular axial, direction from the inside to the outside. Alternatively, the at least one flame-retardant housing component and the at least one impact-resistant housing component are multi-component injection-molded components, and in particular are connected in an integrally bonded manner. This makes it possible to produce the pack housing and thus the battery pack simply and/or, in particular, inexpensively. In particular, the at least one flame-retardant housing component can be located on the at least one impact-resistant housing component, in particular directly. Additionally or alternatively, the term “cast” can be used synonymously for the term “mold”. Further additionally or alternatively, the multi-component injection molding can be a multi-component direct injection molding and/or by means of a rotary plate and/or a multi-component overmolding or recasting and/or a multi-component insert injection molding and/or by means of an insert and/or a plastics injection molding.

In a development of the invention, the battery pack has at least one carrier, in particular a printed circuit board. The at least one carrier carries the pack power contacts, in particular directly. In particular, the at least one carrier has at least one, in particular the, flame-retardant material for protection of the battery pack against fire and/or is different from the pack housing and/or is arranged in the pack housing and/or is form-fittingly connected to the pack housing, in particular directly. This enables the arrangement of the pack power contacts in relation to the pack power housing indirectly, in particular a mechanical connection of the pack power contacts to the pack housing indirectly. In particular, the printed circuit board can be rigid or inflexible or flexible. In particular, the term “flexible printed circuit board” can be used synonymously with the term “conductor foil”. Additionally or alternatively, the at least one carrier can be formed with the at least one flame-retardant material for protection of the battery pack against fire. Further additionally or alternatively, the at least one carrier can be located on the pack housing, in particular directly.

In a development of the invention, the battery pack is designed to be supplied with a maximum drive or nominal current of at least 200 mA (milliamperes), in particular at least 1 A (amperes), and/or at most 1000 A, in particular at most 200 A, in particular 55 A. Additionally or alternatively, the battery pack is designed to be supplied with a nominal voltage of at least 9 V, in particular at least 18 V, and/or at most 100 V, in particular at most 72 V, in particular 36 V. Additionally or alternatively, the battery pack is designed to supply a maximum electrical drive power of at least 200 W (watts), in particular at least 1 kW (kilowatt), and/or at most 10 kW, in particular at most 5 kW, in particular 2 kW. The protection of the battery pack against fire is particularly advantageous for such high values.

In a development of the invention, the battery pack has at least one pack data contact. The at least one pack data contact is designed with at least one data contact point for user-releasable touching of at least one tool data contact of the working tool, in particular the working tool that has been touched, for data transmission between the working tool and the battery pack. In particular, the at least one data contact point, in particular the at least one pack data contact and/or completely, is arranged in the region of the at least one impact-resistant housing component and not, in particular in the region of the at least one flame-retardant housing component. This enables the at least one flame-retardant housing component to be small and/or, in particular thus, the at least one impact-resistant housing component to be large. Additionally or alternatively, this makes it possible to separate the power supply and the data transmission from each other. In particular, the at least one pack data contact can be different and/or separate from the pack power contacts. Additionally or alternatively, the at least one pack data contact may be user-releasable and/or electrical. Further additionally or alternatively, the at least one tool data contact may be complementary or corresponding. Further additionally or alternatively, the data transmission may be automatic. Further additionally or alternatively, the data transmission may be a transmission of data or information about the battery cells. Further additionally or alternatively, the at least one pack data contact can be arranged in and/or on the pack housing, in particular in and/or on an edge of the pack housing. Further additionally or alternatively, the at least one pack data contact can be a plug connector, in particular a tulip or a socket. In particular, the tulip can define the data contact point. Further additionally or alternatively, the at least one tool data contact can be a plug connector, in particular a fin or a pin, in particular which can be pushed into the tulip. Further additionally or alternatively, the at least one impact-resistant housing component may have at least one feed-through recess or opening, in particular a slot, for feeding through the at least one pack data contact and/or the at least one tool data contact for, in particular to, touching. In particular, the data contact point, in particular the pack data contact and/or completely, can be arranged in the pack housing behind the at least one feed-through recess, in particular in a direction, in particular an axial direction, from the outside to the inside. Further additionally or alternatively, the at least one carrier can carry the at least one pack data contact, in particular directly.

The system according to the invention comprises the battery pack as mentioned above and the electrically driven working tool.

The method according to the invention for producing the battery pack as mentioned above comprises the steps of:
producing the at least one flame-retardant housing component and the at least one impact-resistant housing component, in particular by means of injection molding, in particular multi-component injection molding, and
arranging the contact points in the region of the at least one flame-retardant housing component and not the at least one impact-resistant housing component, in particular at a later time.

Further advantages and aspects of the invention can be found in the claims and in the description of exemplary embodiments of the invention, which are explained below with reference to the figures.

### BRIEF DESCRIPTION OF THE DRAWINGS

FIG. 1 is a perspective view of a pack housing of a battery pack according to an embodiment of the invention, in particular one that is open or not closed;

FIG. 2 is a perspective view of an exploded illustration of the pack housing of FIG. 1, comprising at least one flame-retardant housing component and at least one impact-resistant housing component;

FIG. 3 is a rear or back view of the pack housing of FIG. 1;

FIG. 4 is a front view of the pack housing of FIG. 1;

FIG. 5 is a sectional side view of the pack housing of FIG. 1;

FIG. 6 is a sectional plan view of the pack housing of FIG. 1;

FIG. 7 is a sectional plan view of a system comprising the battery pack with the pack housing of FIG. 1 not open or closed and an electrically driven working tool;

FIG. 8 is a rear or back view of the battery pack of FIG. 7; and

FIG. 9 is a perspective view of the system of FIG. 7.

### DETAILED DESCRIPTION OF THE DRAWINGS

FIGS. 7 and 9 show a system 10 comprising a battery pack 1, as shown in FIG. 8, and an electrically driven working tool 4.

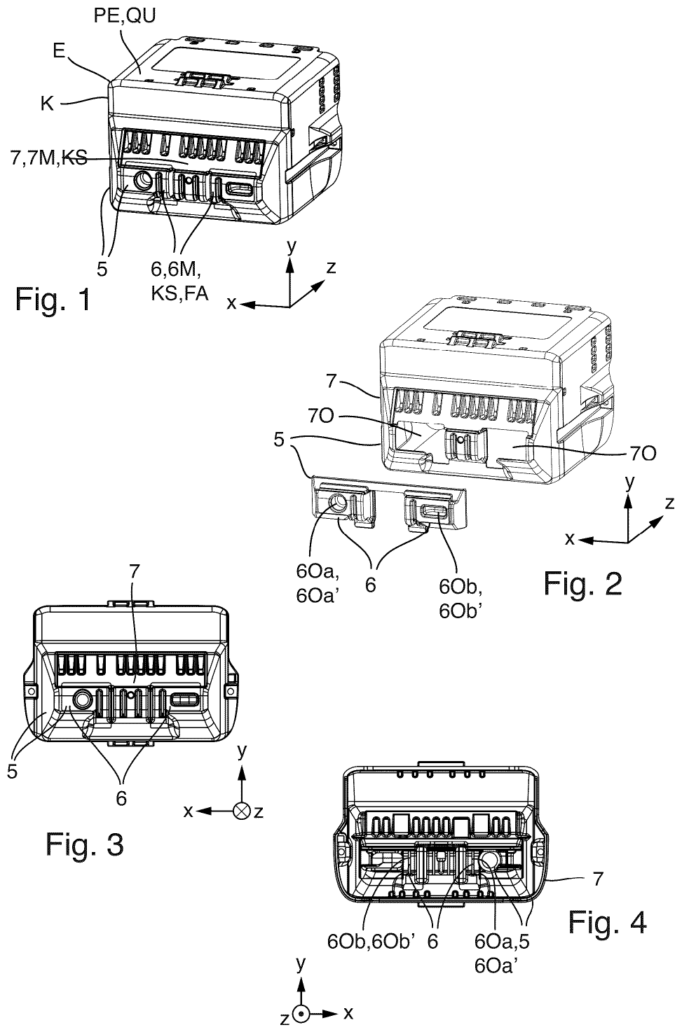

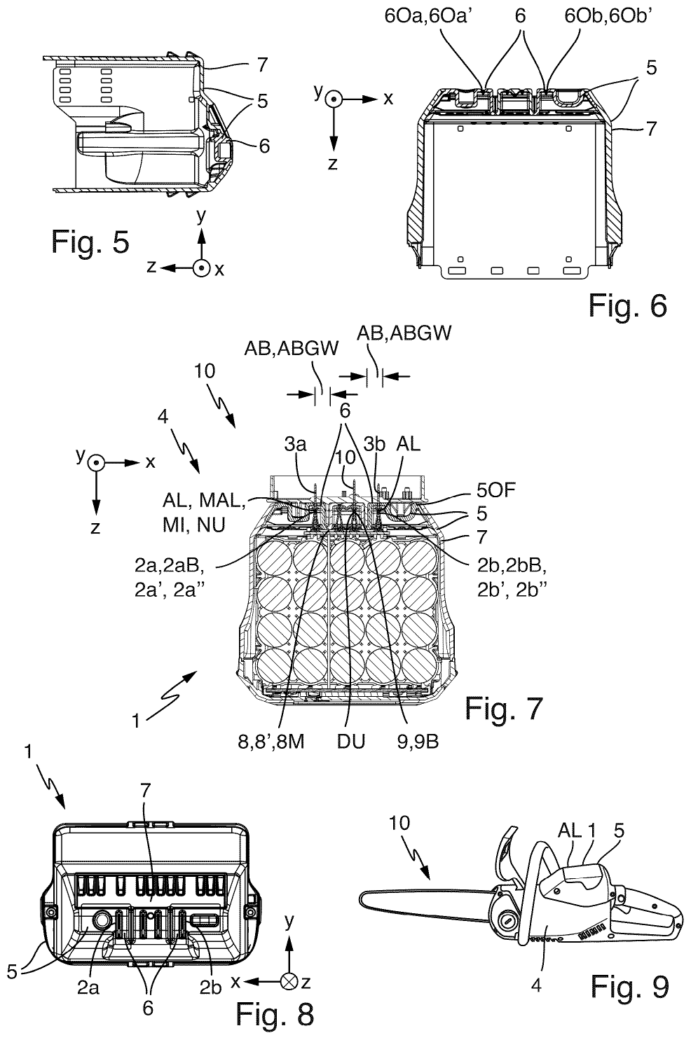

The battery pack 1 has a plurality of, in particular two, pack power contacts 2a, 2b and a pack housing 5, as shown in FIGS. 1 to 6. The pack power contacts 2a, 2b are designed with, in particular touch and thus supply, contact points 2aB, 2bB for user-releasable touching of, in particular two, tool power contacts 3a, 3b of the working tool 4 for supplying the working tool 4 with electrical drive power AL from the battery pack 1. The pack housing 5 has at least, in particular only, one, in particular single, flame-retardant housing component 6 and at least one impact-resistant housing component 7, in particular two impact-resistant housing components 7. The at least one flame-retardant housing component 6 has at least, in particular only, one, in particular single, flame-retardant material 6M for protection of the battery pack 1 against fire. The at least one impact-resistant housing component 7 has at least one impact-resistant material 7M, which is different from the flame-retardant material 6M, for protection of the battery pack 1 against impact. The contact points 2aB, 2bB are arranged in the region of the at least one flame-retardant housing component 6 and not of the at least one impact-resistant housing component 7.

In alternative exemplary embodiments, the pack housing may have a plurality of, in particular two, flame-retardant housing components. Additionally or alternatively, in alternative exemplary embodiments, the pack housing may have only a single impact-resistant housing component or at least three impact-resistant housing components.

In the exemplary embodiment shown, the impact-resistant housing components 7 are a housing container, in particular with five walls, and a housing cover, in particular with one wall, in particular open or not closed by one another, as shown in FIGS. 1 to 6, or closed by one another, as shown in FIGS. 7 and 8.

More specifically, the pack power contacts 2a, 2b are electrical connectors 2a′, 2b′, in particular tulips 2a″, 2b″. In particular, the tulips 2a″, 2b″ define the contact points 2aB, 2bB.

Furthermore, the at least one flame-retardant housing component 6 has at least one feed-through recess 6Oa, 6Ob, in particular two feed-through recesses 6Oa, 6Ob, in particular slots 6Oa′, 6Ob′, for feeding through the pack power contacts and/or the tool power contacts 3a, 3b for contact, in particular the tool power contacts 3a, 3b are fed through. In particular, the contact points 2aB, 2bB, in particular the pack power contacts 2a, 2b, are arranged in the pack housing 5 behind the at least one feed-through recess 6Oa, 6Ob, in particular in a, in particular axial, direction z from the outside to the inside.

In addition, at least one smallest distance AB along a surface 5OF of the pack housing 5, in particular in radial directions x, y, from the contact points 2aB, 2bB, in particular the pack power contacts 2a, 2b, to the at least one impact-resistant housing component 7 is greater than to the at least one flame-retardant housing component 6, in particular on a rear or back side of the pack housing 5, in particular of the housing container. In particular, the contact points 2aB, 2bB, in particular the pack power contacts 2a, 2b, are arranged, in particular completely, surrounded by the at least one flame-retardant housing component 6, in particular on the rear side. Additionally or alternatively, the at least one flame-retardant housing component 6 is arranged, in particular completely, surrounded by the at least one impact-resistant housing component 7, in particular on the rear side.

In the exemplary embodiment shown, the radial directions x, y are non-parallel, in particular orthogonal, to the axial direction z.

Furthermore, the contact points 2aB, 2bB are arranged at a maximum distance with a distance limit value ABGW from the at least one flame-retardant housing component 6. Additionally or alternatively, the contact points 2aB, 2bB are arranged at a minimum distance of more than one, in particular the distance limit value ABGW, from the at least one impact-resistant housing component 7. In particular, the distance limit value ABGW is a minimum of 1 mm and/or a maximum of 5 mm, in particular 3 mm.

In addition, the at least one flame-retardant housing component 6 extends as far as a surface 5OF, in particular the surface 5OF, of the pack housing 5, in particular against a direction z, in particular the, and/or axial, direction z, from the inside to the outside.

Furthermore, the pack housing 5, in particular the at least one impact-resistant housing component 7, has at least one edge K, in particular twelve edges K, and/or at least one corner E, in particular eight corners E, in particular form of a parallelepiped PE, in particular a cuboid QU. The at least one flame-retardant housing component 6 does not extend as far as the at least one edge K and/or the at least one corner E, in particular along one, in particular the, surface 5 OF of the pack housing 5.

In the exemplary embodiment shown, the pack housing 5, in particular the at least one impact-resistant housing component 7, has a height, in particular in the direction y, of at least 2.5 centimeters (cm) and/or a maximum of 10 cm, in particular 5 cm, and/or a width, in particular in the direction x, of at least 5 cm and/or a maximum of 20 cm, in particular 10 cm, and/or a depth, in particular in the direction z, of at least 7.5 cm and/or a maximum of 30 cm, in particular 15 cm.

In addition, the at least one flame-retardant housing component 6 has a classification of UL94V-0.

Furthermore, the at least one flame-retardant housing component 6 consists partially or entirely of plastic KS, in particular PA6/6 (GF0 to 45), with at least one flame-retardant additive FA. Additionally or alternatively, the at least one impact-resistant housing component 7 consists partially or completely of, in particular the, plastic KS with less or no flame-retardant additive.

In the exemplary embodiment shown, the at least one impact-resistant housing component 7, in particular the housing container, in particular on its rear side, has at least one receiving recess 70, in particular two receiving recesses 70, for receiving, in particular when the housing container is open or not closed, and in particular for form-fitting connection of, the at least one flame-retardant housing component 6, in particular against a direction z, in particular the and/or axial direction z, from the inside to the outside. In particular, the at least one flame-retardant housing component 6 is received and form-fittingly connected.

In alternative exemplary embodiments, the at least one flame-retardant housing component and the at least one impact-resistant housing component can be multi-component injection-molded components, and in particular can be joined by an integrally bonded connection.

In addition, the battery pack 1 has at least one, in particular only one, carrier 8, in particular a printed circuit board 8′. The at least one carrier 8 carries the pack power contacts 2a, 2b. In particular, the at least one carrier 8 comprises at least one, in particular the, flame-retardant material 8M for protection of the battery pack 1 against fire and/or is different from the pack housing 5 and/or is arranged in the pack housing 5 and/or is form-fittingly connected to the pack housing 5.

Furthermore, the battery pack 1 is designed for the supply with a maximum drive current MI of at least 200 mA, in particular at least 1 A, and/or at most 1000 A, in particular at most 200 A, in particular 55 A. Additionally or alternatively, the battery pack 1 is designed for the supply, in particular is supplied, with a nominal voltage NU of at least 9 V, in particular at least 18 V, and/or at most 100 V, in particular at most 72 V, in particular 36 V. Further additionally or alternatively, the battery pack 1 is designed for the supply, in particular is supplied, with a maximum electrical drive power MAL of at least 200 W, in particular at least 1 kW, and/or at most 10 kW, in particular at most 5 kW, in particular 2 kW.

In addition, the battery pack 1 has at least one pack data contact 9. The at least one pack data contact 9 is designed, in particular touches and thus transmits, with at least one data contact point 9B for user-releasable contacting of at least one tool data contact 10 of the working tool 4 for data transmission DU between the working tool 4 and the battery pack 1. In particular, the at least one data contact point 9B is arranged in the region of the at least one impact-resistant housing component 7 and not of the at least one flame-retardant housing component 6.

In alternative exemplary embodiments, the at least one data contact point can be arranged in the region of the at least one flame-retardant housing component and/or not the at least one impact-resistant housing component.

The method according to the invention for producing the battery pack 1 has the following steps:
producing the at least one flame-retardant housing component 6 and the at least one impact-resistant housing component 7, in particular by means of injection molding, in alternative exemplary embodiments multi-component injection molding, and
arranging the contact points 2aB, 2bB in the region of the at least one flame-retardant housing component 6 and not the at least one impact-resistant housing component 7.

In the exemplary embodiment shown, the pack power contacts 2a, 2b are and/or will be arranged in the pack housing 5, in particular by the carrier 8, in particular when the housing container is open or not closed. The housing container, in particular a front side of the housing container, is and/or will be closed by the housing cover, in particular at a later time.

As the exemplary embodiments shown and explained above make clear, the invention provides an advantageous battery pack, an advantageous system comprising the battery pack and an electrically driven working tool, and an advantageous method for producing the battery pack, each of which has improved properties.

1.-15. (canceled)

16. A battery pack, comprising:
a plurality of pack power contacts, wherein the pack power contacts are configured with contact points for user-releasable touching of tool power contacts of an electrically driven working tool for supplying the working tool with electrical drive power from the battery pack; and
a pack housing, wherein the pack housing has at least one flame-retardant housing component and at least one impact-resistant housing component,
wherein the at least one flame-retardant housing component comprises at least one flame-retardant material for protection of the battery pack against fire,
wherein the at least one impact-resistant housing component comprises at least one impact-resistant material, different from the flame-retardant material, for protection of the battery pack against impact, and
wherein the contact points are arranged in a region of the at least one flame-retardant housing component and not of the at least one impact-resistant housing component.

17. The battery pack according to claim 16, wherein
the pack power contacts are tulip plug connectors, and
the tulip plug connectors define the contact points.

18. The battery pack according to claim 16, wherein
the at least one flame-retardant housing component has at least one feed-through recess for feeding through the pack power contacts and/or the tool power contacts for touching, and
the contact points are arranged in the pack housing behind the at least one feed-through recess in a direction from outside to inside.

19. The battery pack according to claim 16, wherein
at least one smallest distance along a surface of the pack housing in radial directions from the contact points to the at least one impact-resistant housing component is greater than to the at least one flame-retardant housing component, and
the contact points are arranged surrounded by the at least one flame-retardant housing component, and/or
the at least one flame-retardant housing component is arranged surrounded by the at least one impact-resistant housing component.

20. The battery pack according to claim 16, wherein
the contact points are arranged at a maximum distance with a distance limit value from the at least one flame-retardant housing component, and/or
the contact points are arranged at a minimum distance of more than the distance limit value from the at least one impact-resistant housing component,
wherein the distance limit value is a minimum of 1 mm and/or a maximum of 5 mm.

21. The battery pack according to claim 16, wherein
the at least one flame-retardant housing component extends up to a surface of the pack housing against a direction from inside to outside.

22. The battery pack as claimed in claim 16, wherein
the at least one impact-resistant housing component has at least one edge and/or at least one corner, and
the at least one flame-retardant housing component does not extend as far as the at least one edge and/or the at least one corner along a surface of the pack housing.

23. The battery pack according to claim 16, wherein
the at least one flame-retardant housing component has a classification of UL94V-0.

24. The battery pack according to claim 16, wherein
the at least one flame-retardant housing component is made partially or completely of plastic with at least one flame-retardant additive, and/or
the at least one impact-resistant housing component is made partially or completely of the plastic with less or no flame-retardant additive.

25. The battery pack according to claim 16, wherein
the at least one impact-resistant housing component has at least one receiving recess for receiving the at least one flame-retardant housing component against a direction from the inside to the outside, or
the at least one flame-retardant housing component and the at least one impact-resistant housing component are multi-component injection-molded components, and are joined by an integrally bonded connection.

26. The battery pack according to claim 16, further comprising:
at least one carrier, wherein
the at least one carrier carries the pack power contacts, and
the at least one carrier comprises at least one flame-retardant material for protection of the battery pack against fire and/or is different from the pack housing and/or is arranged in the pack housing and/or is form-fittingly connected to the pack housing.

27. The battery pack according to claim 16, wherein at least one of:
(i) the battery pack is designed to supply a maximum drive current of at least 200 mA and/or at most 1000 A,
(ii) the battery pack is designed for supply with a nominal voltage of at least 9 V and/or at most 100 V,
(iii) the battery pack is designed for supply with a maximum electrical drive power of at least 200 W and/or at most 10 kW.

28. The battery pack according to claim 16, further comprising:
at least one pack data contact, wherein
the at least one pack data contact is designed with at least one data contact point for user-releasable touching of at least one tool data contact of the working tool for data transmission between the working tool and the battery pack, and
the at least one data contact point is arranged in a region of the at least one impact-resistant housing component and not of the at least one flame-retardant housing component.

29. The battery pack according to claim 18, wherein
the at least one feed-through recess is a slot.

30. The battery pack according to claim 19, wherein
the pack power contacts are completely surrounded by the at least one flame-retardant housing component, and/or
the at least one flame-retardant housing component is completely surrounded by the at least one impact-resistant housing component.

31. The battery pack according to claim 22, wherein the pack housing is in the form of a parallelpiped.

32. The battery pack according to claim 22, wherein the pack housing is in the form of a cuboid.

33. A system, comprising:
the battery pack according to claim 16; and
the electrically driven working tool.

34. A method for producing a battery pack, wherein the battery pack comprises:
a plurality of pack power contacts, wherein the pack power contacts are configured with contact points for user-releasable touching of tool power contacts of an electrically driven working tool for supplying the working tool with electrical drive power from the battery pack; and
a pack housing, wherein the pack housing has at least one flame-retardant housing component and at least one impact-resistant housing component,
wherein the at least one flame-retardant housing component comprises at least one flame-retardant material for protection of the battery pack against fire,
wherein the at least one impact-resistant housing component comprises at least one impact-resistant material, different from the flame-retardant material, for protection of the battery pack against impact,
the method comprising the steps of:
producing the at least one flame-retardant housing component and the at least one impact-resistant housing component via injection molding; and
arranging the contact points in a region of the at least one flame-retardant housing component and not the at least one impact-resistant housing component.
